(19) United States
(12) Patent Application Publication
(10) Pub. No.: US 2020/0161721 A1
(43) Pub. Date: May 21, 2020

(54) BATTERY PACKS WITH SEALED COLD PLATES FOR ELECTRIC VEHICLES

(71) Applicant: SF Motors, Inc., Santa Clara, CA (US)

(72) Inventor: Jiaxian Wang, Santa Clara, CA (US)

(21) Appl. No.: 16/193,692

(22) Filed: Nov. 16, 2018

(51) Int. Cl. H01M 10/613; H01M 10/625; H01M 10/647

(52) U.S. Cl. CPC H01M 10/613; H01M 10/625; B60L 11/1879; H01M 2220/20; H01M 10/647

(57) ABSTRACT

Apparatuses, systems, and methods of providing electric power to electric vehicles. A housing can have a bottom panel. A battery module can be arranged within the housing. An inlet port and outlet port can be defined through the bottom panel to circulate fluid. A cold plate can be disposed along a bottom surface of the bottom panel. The cold plate can be thermally coupled with the battery module via the bottom panel. The cold plate can have a main intake and a main outtake channel spanning along a top surface to circulate the fluid. The cold plate can a module channel spanning within a module region. The module channel can convey the fluid from the main intake channel to the main outtake channel to transfer heat from the battery module. A sealing element can be arranged along a perimeter region of the top surface to mechanically seal the cold plate.

### BACKGROUND

There is an increasing demand for reliable and higher capacity battery cells for high power, higher performance battery packs, to support applications in plug-in hybrid electrical vehicles (PHEVs), hybrid electrical vehicles (HEVs), or electrical vehicle (EV) systems, for example. The temperature of battery pack modules can increase under operating conditions.

### SUMMARY

The present disclosure is directed to battery packs in electric vehicle. A battery pack can have a cold plate mechanically coupled (e.g., sealed) with a bottom plate of the battery pack to transfer heat away from a battery module housed in the battery pack using fluid (e.g., coolant). Such a configuration allows for improvement in integrity of the battery pack by lowering a risk of fluid leakage.

At least one aspect is directed to an apparatus to provide electric power to components in electric vehicles. The apparatus can include a housing for a battery pack. The housing can be disposed in an electric vehicle to power the electric vehicle. The housing can have a bottom panel partially defining a cavity. The bottom panel can have a top surface and a bottom surface. The apparatus can include a battery module. The battery module can be arranged within the cavity of the housing for the battery pack. The battery module can be supported by at least a portion of the top surface of the bottom panel and can be thermally coupled with the top surface of the bottom panel. The battery module can have a plurality of battery cells to store electrical energy. The apparatus can include an inlet port. The inlet port can be defined through the top surface and the bottom surface of the bottom panel to receive fluid from outside the housing. The apparatus can include an outlet port. The outlet port can be defined through the top surface and the bottom surface of the bottom panel to release the fluid from within the housing. The apparatus can include a cold plate. The cold plate can be disposed along the bottom surface of the bottom panel of the housing. The cold plate can circulate the fluid. The cold plate can be thermally coupled with the battery module via the bottom panel. The cold plate can have a main intake channel. The main intake channel can be defined spanning along a top surface of the cold plate. The main intake channel can have an intake point aligned with the inlet port of the bottom panel to receive the fluid into the cold plate. The cold plate can have a main outtake channel. The main outtake channel can be defined spanning along the top surface of the cold plate. The main outtake channel can have an outtake point aligned with the outlet port of the bottom panel to release the fluid out of the cold plate. The cold plate can include a module channel. The module channel can be defined spanning within a module region of the top surface of the cold plate. The module channel can convey the fluid from the main intake channel via an ingress point of the module region to the main outtake channel via an egress point of the module region to transfer heat from the battery module. The apparatus can include a sealing element. The sealing element can be arranged along a perimeter region of the top surface of the cold plate to mechanically seal the cold plate with the bottom surface of the bottom panel of the housing.

At least one aspect is directed to an electric vehicle. The electric vehicle can include one or more components. The electric vehicle can include a housing for a battery pack to power the one or more components. The housing can have a bottom panel partially defining a cavity. The bottom panel can have a top surface and a bottom surface. The electric vehicle can include a battery module. The battery module can be arranged within the cavity of the housing for the battery pack. The battery module can be supported by at least a portion of the top surface of the bottom panel and can be thermally coupled with the top surface of the bottom panel. The battery module can have a plurality of battery cells to store electrical energy. The electric vehicle can include an inlet port. The inlet port can be defined through the top surface and the bottom surface of the bottom panel to receive fluid from outside the housing. The electric vehicle can include an outlet port. The outlet port can be defined through the top surface and the bottom surface of the bottom panel to release the fluid from within the housing. The electric vehicle can include a cold plate. The cold plate can be disposed along the bottom surface of the bottom panel of the housing. The cold plate can circulate the fluid. The cold plate can be thermally coupled with the battery module via the bottom panel. The cold plate can have a main intake channel. The main intake channel can be defined spanning along a top surface of the cold plate. The main intake channel can have an intake point aligned with the inlet port of the bottom panel to receive the fluid into the cold plate. The cold plate can have a main outtake channel. The main outtake channel can be defined spanning along the top surface of the cold plate. The main outtake channel can have an outtake point aligned with the outlet port of the bottom panel to release the fluid out of the cold plate. The cold plate can a module channel. The module channel can be defined spanning within a module region of the top surface of the cold plate. The module channel can convey the fluid from the main intake channel via an ingress point of the module region to the main outtake channel via an egress point of the module region to transfer heat from the battery module. The electric vehicle can include a sealing element. The sealing element can be arranged along a perimeter region of the top surface of the cold plate to mechanically seal the cold plate with the bottom surface of the bottom panel of the housing.

At least one aspect is directed to a method of providing electric power to components in electric vehicles. The method can include disposing a housing for a battery pack in an electric vehicle to power the electric vehicle. The housing can have a bottom panel partially defining a cavity. The bottom panel can have a top surface and a bottom surface. The method can include arranging a battery module within the cavity of the housing for the battery pack. The battery module can be supported by at least a portion of the top surface of the bottom panel and thermally coupled with the top surface of the bottom panel. The battery module can have a plurality of battery cells to store electrical energy. The method can include defining an inlet port and an outlet port each through the top surface and the bottom surface of the bottom panel to receive fluid from outside the housing. The method can include disposing a cold plate along the bottom surface of the bottom panel of the housing to circulate the fluid. The cold plate can have a main intake channel. The main intake channel can be defined spanning along a top surface of the cold plate. The main intake channel can have an intake point aligned with the inlet port of the bottom panel to receive the fluid into the cold plate. The cold plate can have a main outtake channel. The main outtake channel can be defined spanning along the top surface of the cold plate. The main outtake channel can have an outtake point aligned with the outlet port of the bottom panel to release the fluid out of the cold plate. The cold plate can include a module channel. The module channel can be defined spanning within a module region of the top surface of the cold plate. The module channel can convey the fluid from the main intake channel via an ingress point of the module region to the main outtake channel via an egress point of the module region to transfer heat from the battery module. The method can include arranging a sealing element along a perimeter region of the top surface of the cold plate to mechanically seal the cold plate with the bottom surface of the bottom panel of the housing.

At least one aspect is directed toward a method. The method can include providing an apparatus. The apparatus can include a housing for a battery pack. The housing can be disposed in an electric vehicle to power the electric vehicle. The housing can have a bottom panel partially defining a cavity. The bottom panel can have a top surface and a bottom surface. The apparatus can include a battery module. The battery module can be arranged within the cavity of the housing for the battery pack. The battery module can be supported by at least a portion of the top surface of the bottom panel and can be thermally coupled with the top surface of the bottom panel. The battery module can have a plurality of battery cells to store electrical energy. The apparatus can include an inlet port. The inlet port can be defined through the top surface and the bottom surface of the bottom panel to receive fluid from outside the housing. The apparatus can include an outlet port. The outlet port can be defined through the top surface and the bottom surface of the bottom panel to release the fluid from within the housing. The apparatus can include a cold plate. The cold plate can be disposed along the bottom surface of the bottom panel of the housing. The cold plate can circulate the fluid. The cold plate can be thermally coupled with the battery module via the bottom panel. The cold plate can have a main intake channel. The main intake channel can be defined spanning along a top surface of the cold plate. The main intake channel can have an intake point aligned with the inlet port of the bottom panel to receive the fluid into the cold plate. The cold plate can have a main outtake channel. The main outtake channel can be defined spanning along the top surface of the cold plate. The main outtake channel can have an outtake point aligned with the outlet port of the bottom panel to release the fluid out of the cold plate. The cold plate can include a module channel. The module channel can be defined spanning within a module region of the top surface of the cold plate. The module channel can convey the fluid from the main intake channel via an ingress point of the module region to the main outtake channel via an egress point of the module region to transfer heat from the battery module. The apparatus can include a sealing element. The sealing element can be arranged along a perimeter region of the top surface of the cold plate to mechanically seal the cold plate with the bottom surface of the bottom panel of the housing.

### BRIEF DESCRIPTION OF THE DRAWINGS

The accompanying drawings are not necessarily intended to be drawn to scale. Like reference numbers and designations in the various drawings indicate like elements. For purposes of clarity, not every component may be labelled in every drawing. In the drawings:

FIG. 1 depicts an exploded perspective, axonometric view of a topside of an example apparatus for powering electric vehicles;

FIG. 2 depicts an isometric view of an example apparatus for powering electric vehicles;

FIG. 3 depicts an isometric view of an example cold plate and sealing element of an apparatus for powering electric vehicles;

FIG. 4 depicts a close-up isometric view of an example cold plate of an apparatus for powering electric vehicles;

FIG. 5 is a block diagram depicting a cross-sectional view of an example electric vehicle installed with a battery pack;

FIG. 6 is a flow diagram depicting an example method of assembling a battery pack for powering electric vehicles; and

FIG. 7 is a flow diagram depicting an example method of providing an apparatus to an electric vehicle.

### DETAILED DESCRIPTION

Following below are more detailed descriptions of various concepts related to, and implementations of, methods, apparatuses, devices, and systems of temperature control for a battery pack or other energy storage device. The various concepts introduced above and discussed in greater detail below may be implemented in any of numerous ways.

Described herein are battery packs with integrated cold plates in electric vehicles for an automotive configuration. An automotive configuration includes a configuration, arrangement or network of electrical, electronic, mechanical or electromechanical devices within a vehicle of any type. An automotive configuration can include battery cells for battery packs in electric vehicles (EVs). EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. EVs can include various components that run on electrical power. These various components can include an electric engine, an entertainment system (e.g., a radio, display screen, and sound system), on-board diagnostics system, and electric control units (ECUs) (e.g., an engine control module, a transmission control module, a brake control module, and a body control module), among other components.

A battery pack housing a set of battery modules (sometimes referred herein as battery blocks) containing battery cells can be installed in an EV to supply electrical power to the components of the EV. When maintained in an optimal temperature-controlled environment, the battery modules of the battery pack can achieve proper operation, high-performance, and long life. Under one approach to control the temperature of the battery modules in the battery pack, at least two sets of pipes may be included in and around each battery module of the battery pack to circulate and evacuate the coolant. An intake pipe can receive coolant from outside the battery pack. An outtake pipe can be connected to the intake pipe via a return, and can release the coolant from the battery pack. These sets of pipes can be comprised of multiple segments, each connected to another via seals or joints. By passing the coolant through the set of pipes, heat may be transferred away from the battery modules, thereby reducing the temperature.

While this approach can maintain the battery pack in an optimal temperature-controlled environment, there may be a number of technical drawbacks with this schema. The leakage of coolant from the pipes can cause a short circuit or a failure (e.g., fire or explosion) within the battery pack, especially when the coolant enters into the battery modules containing the battery cells. To avoid leakage of coolant into the battery modules within the battery pack, the pipes can be sealed around the connections between each segment. With the number of joints connecting the various segments of the pipes, however, prevent such leakage can become difficult and the risk of coolant leakage can be significantly increased. In addition, as the pipes deteriorates from aging and use, the likelihood of rupture of the joints or seals connecting the segments of the pipes can increase, thereby further amplifying the risk of leakage.

In order to alleviate and address the technical challenges with such approaches in evacuating heat from battery packs, the installation of pipes within the battery pack can be minimized or eliminated with the use of cold plates sealed along a surface of the battery pack. A bottom panel of the housing for the battery pack can have an inlet port and an outlet port. The inlet port can receive coolant from outside the housing. The outlet port can release the coolant form within the housing. A cold plate can be arranged along a bottom surface of the bottom panel of the battery pack. The cold plate itself can be a monolithic structure, with each structure or element formed from the monolithic structure. The cold plate can have a main intake channel to receive the coolant and a main outtake channel to circulate the coolant throughout the cold plate. The main intake channel can extend generally through a central portion of the top surface of the cold plate, and can receive the coolant from the inlet port defined on the bottom panel of the housing. The main outtake channel can span along a perimeter portion of the top surface of the cold plate, and can release the coolant to the outlet port on the bottom panel of the housing.

The cold plate can also have a set of module regions defined along the top surface of the cold plate flush with the bottom panel of the battery pack. Each module region can be thermally coupled with one of the battery modules disposed within the battery pack, and can be longitudinally aligned with the battery module arranged above the module region. Each module region can also have a module channel spanning across the top surface of the cold plate corresponding to the module region. The module channel can have an ingress point connected to the main intake channel to receive the coolant into the module region. The module channel can have an egress point connected to the main outtake channel to release the coolant. The module channel itself can meander or wind through the module region to circulate and spread the coolant to transfer heat away from the battery module aligned above. As the cold plate can be a monolithic structure, all the channels can be formed from the monolithic structure (e.g., engraving, etching, or bruising). As such, the main intake, main outtake, and module channels can lack any segments or seals or joints between segments as with the approach using the pipes.

To prevent leakage of coolant from the cold plate, the cold plate can be mechanically coupled to the bottom surface of the bottom panel of the housing for the battery pack. The cold plate can have a trench spanning along the perimeter portion of the top surface. A sealing component can be included in the trench to form a mechanical seal (e.g., a hermetic seal) against the bottom surface of the bottom panel. With the mechanical seal formed, the cold plate can hold the coolant in the volume defined between the channels defined along the top surface and the bottom surface of the bottom panel of the housing. The coolant can travel through the volume defined between the channels of the top surface of the cold plate and the bottom surface of the bottom panel to transfer heat away from the battery modules. The coolant can be pumped into the cold plate via the inlet port of the housing, and can be distributed to each module channel through the main intake channel. The coolant can be released from the cold plate via the main outtake channel, and can be drained from the housing through the outlet port. An envelope structure can be added to secure the cold plate against the bottom surface of the bottom panel, thereby further improving the quality of mechanical seal between the cold plate and the bottom surface of the bottom panel.

In this manner, the utilization of pipes can be confined to the side that the conduits of the distribution plate and the inlets and outlets for the battery pack are fluidly coupled. As a result, any deleterious effect of coolant leakage from the pipe can be external to the battery pack. By limiting the usage of pipes from the battery pack, the likelihood of rupture of the joints or seals connecting the segments of the pipes can be reduced or eliminated. In addition, the risk of leakage of coolant into the battery cells of the battery modules can be decreased. Moreover, even if the pipes degrade from usage and again, replacement of the pipes can be less difficult, as the pipes can be placed external to the battery pack.

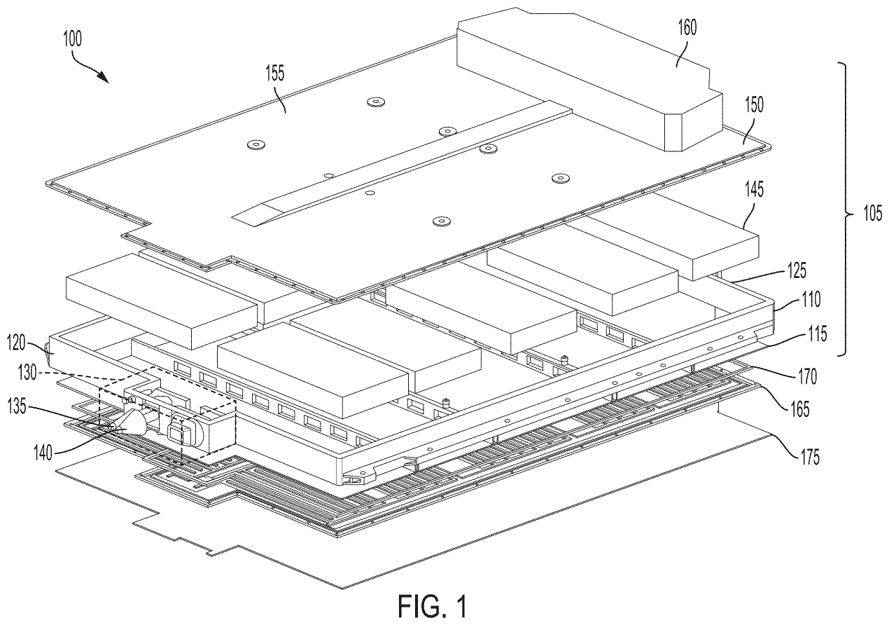

FIG. 1, among others, depicts an isometric view of a topside of a system or an apparatus 100 for powering electric vehicles. The apparatus 100 can be installed or included in an electric vehicle. The apparatus can include a battery pack 105. The battery pack 105 can store electrical energy to supply electrical energy to components in the electric vehicle electrically coupled with the battery pack 105. The battery pack 105 can include a positive terminal and a negative terminal to electrically couple with the various components of the electric vehicle. The battery pack 105 can include a housing 110. The housing 110 can be comprised of a thermally conductive material. The thermally conductive material for the housing 110 can include a ceramic material (e.g., silicon nitride, silicon carbide, titanium carbide, zirconium dioxide, and beryllium oxide), a metal (e.g., aluminum, copper, iron, tin, lead, and various alloys), and a thermoplastic material (e.g., acrylic glass, polyethylene, polypropylene, polystyrene, or polyvinyl chloride), among others. The housing 110 for the battery pack 105 can be of various shapes. The housing 110 can be prism with a polygonal base, such as a triangle, a square, a rectangle (e.g., as depicted), a pentagon, or a hexagon, among others. The housing 110 can be a cylinder with a circular, ovular, or elliptical base, among others. A length of the housing 110 can range between 1771 mm to 2171 mm. A width of the housing 110 can range between 1206 mm to 1606 mm. A height of the housing 110 can range between 83 mm and 123 mm.

The housing 110 can have at least two longitudinal sides for top and bottom and one or more lateral sides between the at least two longitudinal sides. In a rectangular prism example as depicted, the housing 110 can include four side walls, including a first side wall 120 and a second side wall 125. The first side wall 120 and the second side wall 125 can form a width of the housing 110. The first side wall 120 and the second side wall 125 can be on opposing sides. In this example, the housing 110 can also have a bottom panel 115 along a bottom longitudinal side. The bottom panel 115 can form a portion of the housing 110. The bottom panel 115 can be separate from the housing 110, and can be part of a component disposed beneath the housing 110. The side wall 120 can correspond to a width of the housing 110 (e.g., as depicted). The width of the housing 110 can range between 1206 mm to 1606 mm. The length of the housing 110 can range between 1771 mm to 2171 mm. A height of the side walls can correspond to a height of the housing 110. The bottom panel 115 can have a length ranging between 83 mm to 123 mm. The bottom panel 115 can have a width ranging between 1166 mm to 1566 mm. The bottom panel 115 can have a thickness ranging between 2 mm to 6 mm.

Along at least one of the lateral sides (e.g., the first side wall 120 or the second side wall 125) of the housing 110 for the battery pack 105, the apparatus 100 can include at least one support structure 130 situated thereupon. The apparatus 100 can include one support structure 130 on the first side wall 120 (e.g., as depicted). The apparatus 100 can include one support structure 130 on the second side wall 125. The support structure 130 can be arranged, situated, or otherwise included on an external surface of at least one of the lateral sides (e.g., the first side wall 120 or the second side wall 125) of the housing 110. The support structure 130 can at least partially span the at least one lateral side of the housing 110 along an interior or an exterior (e.g., as depicted) of the housing 110. A length of the support structure 130 along the at least one lateral side of the housing 110 can be less than a length of one of the lateral sides (e.g., the first side wall 120 or the second side wall 125). The length of the support structure 130 along the lateral side of the housing 110 can range between 83 mm to 123 mm. For example, as illustrated, the support structure 130 can be situated to the second side wall 120 of the housing 110, and can span a portion of the external surface of the first side wall 120. The support structure 130 can extend or protrude from the at least one lateral side of the housing 110 on the exterior (e.g., as depicted). The support structure 130 can be arranged on the at least one lateral side of the housing 110 within the interior of the housing 110. A width of the support structure 130 extending along the exterior or within the interior of the housing 110 can range between 390 mm to 430 mm. A height of the support structure 130 can correspond to the height of the housing 110, and can range between 83 mm to 123 mm.

The support structure 130 can define or include at least one outlet 135 and at least one inlet 140 along at least one lateral side of the support structure to circulate coolant (or other fluid) through the housing 110 for the battery pack 105. The outlet 135 and the inlet 140 each can include an aperture or a hole along at least one lateral surface the support structure 130. The coolant can be a liquid and can include, for example, water, antifreeze, polyalkylene glycol, liquid nitrogen, hydrofluorocarbons (HFCs), and perfluorocarbons (PFCs), among others. The coolant can be gaseous, and can include, for example, hydrogen, helium, carbon dioxide, sulfur hexafluoride, among others. The outlet 135 and the inlet 140 each can be of any shape, and can be triangular, rectangular, polygonal, circular, or elliptical, among others. The outlet 135 and the inlet 140 can each have a length ranging between 23 mm to 43 mm. The outlet 135 and the inlet 140 can each have a width ranging between 8 mm to 28 mm.

The outlet 135 can release or drain the coolant from the housing 110 of the battery pack 105. The outlet 135 can be fluidly coupled (e.g., using a pipe) with a disposal external to the housing 110 to receive the coolant. The disposal can include a fluid tank containing or holding the coolant, and can be the same fluid tank as the source feeding the coolant to the housing 110 via the inlet 135. The outlet 135 can be fluidly coupled with the external source via a pressure regulator. The pressure regulator can control an outtake flow rate of the coolant released from the housing 110 for the battery pack 105 via the outlet 135. The pressure regulator can include a loading element to apply pressure to the coolant drained from the housing 110 via the outlet 135. The outlet 135 itself can also include an outlet control valve to control the outtake flow rate on the outlet 135 of the support structure 130. The outlet control valve of the outlet 135 can include an actuator and a restrictive member controlled by the actuator to set the outtake flow rate.

The inlet 140 can obtain or receive the coolant from outside the housing 110 of the battery pack 105. The inlet 140 can be fluidly coupled (e.g., using a pipe) with a source external to the housing 110 to receive the coolant. The source can include a fluid tank containing or holding the coolant. The inlet 140 can be fluidly coupled with the external source via a pressure regulator. The pressure regulator can control an intake flow rate of the coolant fed into the housing 110 for the battery pack 105 via the inlet 140. The pressure regulator can include a loading element to apply pressure to the coolant fed into the housing 110 via the inlet 140. The inlet 140 itself can also include an inlet control valve to control the intake flow rate on the inlet 140 of the support structure 130. The inlet control valve of the inlet 140 can include an actuator and a restrictive member controlled by the actuator to set the intake flow rate.

Within the housing 110 for the battery pack 105, the apparatus 100 can include a set of one or more battery modules 145 that can store electrical energy to power the electric vehicle. Each battery module 145 can be disposed, arranged, or otherwise included in the cavity 200 of the housing 110. The set of battery modules 145 can be arranged in parallel, in series, or both in parallel and in series (e.g., as depicted). The set of battery modules 145 can be supported by at least a portion of the bottom panel 115. At least a portion of a bottom surface of each battery module 145 can be in contact with a portion of the top surface of the bottom panel 115. At least a portion of the bottom surface of each battery module 145 can be flush with the top surface of the bottom panel 115. The set of battery modules 145 can be situated or arranged above one or more components arranged along the bottom panel 115. The one or more components can reside between the bottom surface of one of the battery modules 145 and the top surface of the bottom panel 115. The top surface of the bottom panel 115 can thus support the set of battery modules 145 via the one or more components. The battery module 145 can have or define a positive terminal and a negative terminal. The positive terminal for the battery module 145 can correspond to or can be electrically coupled with the positive terminals of the set of battery cells in the battery module 145. The negative terminal for the battery module 145 can correspond to or can be electrically coupled with the negative terminals of the set of battery cells in the battery module 145. Both the positive terminal and the negative terminal of the battery module 145 can be defined or located along a top surface of the battery module 145 (e.g., as depicted).

Each battery module 145 can support or include a set of battery cells to store electrical energy. Each battery module 145 can define or include one or more holders for the battery cells. Each holder can contain, support, or house at least one battery cell. The battery module 145 can be comprised of a thermally conductive and electrically insulative material. The material of the battery module 145 can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others. A shape of the battery module 145 can be a prismatic casing with a polygonal base, such as a triangle, a square, a rectangle (e.g., as depicted), a pentagon, or a hexagon, among others. The shape of the battery module 145 can include a cylindrical casing or cylindrical cell with a circular, ovular, or elliptical base, among others. A height of each battery module 145 can range between 60 mm to 100 mm. A width or diameter of each battery module 145 can range between 250 mm to 350 mm. A length of each battery module 145 can range between 400 mm to 800 mm.

The battery cells included in the battery modules 145 can include a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. Each battery cell in the battery modules 145 can have or define a positive terminal and a negative terminal. Both the positive terminal and the negative terminal can be along a top surface of the battery cell. The shape of the battery cell can be a prismatic casing with a polygonal base, such as a triangle, square, a rectangular, a pentagon, or a hexagon. The shape of the battery cell can also be cylindrical casing or cylindrical cell with a circular (e.g., as depicted), ovular, or elliptical base, among others. A height of each battery cell can range between 50 mm to 90 mm. A width or diameter of each battery cell can range between 11 mm to 31 mm. A length or diameter of each battery cell can range between 11 mm to 31 mm.

Along the longitudinal side of the housing 110 (e.g., the top side as depicted), the apparatus 100 can include at least one lid structure 150. The lid structure 150 can be arranged on the top longitudinal side of the housing 110 in a spacing defined within the side walls of the housing 110. The lid structure 150 can be comprised of a thermally conductive material. The thermally conductive material for the lid structure 150 can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others. A length of the lid structure 150 can range between 1771 mm to 2171 mm. A width of the lid structure 150 can range between 1206 mm to 1606 mm. A height of the lid structure 150 can range between 7 mm to 18 mm.

The lid structure 150 can include a module current collector 155 and a terminal port structure 160. The module current collector 155 can span along a top surface of the lid structure 150 (e.g., as depicted). The module current collector 155 can house or include a set of conductive lines to convey electrical power from the battery pack 105 to the components of the electrical vehicle. The set of conductive lines of the module current collector 155 can include at least one positive terminal conductive line and at least one negative terminal conductive line. The set of conductive lines can be comprised of electrically conductive material. The electrically conductive material can include as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The module current collector 155 can protrude from the top surface of the lid structure 150 (e.g., as depicted) or can be embedded within the lid structure 150. The terminal port structure 160 can be arranged or included along the top surface of the lid structure 150 and can protrude from the top surface of the top surface of the lid structure 150 (e.g., as depicted).

The terminal port structure 160 can define or include at least one positive terminal port for the positive terminal and at least one negative terminal port for the negative terminal of the battery pack 105. The positive terminal port of the terminal port structure 160 can be electrically coupled with the positive terminal conductive line of the module current collector 155. The negative terminal port of the terminal port structure 160 can be electrically coupled with the negative terminal conductive line of the module current collector 155. The positive terminal and the negative terminal of each battery module 145 can be electrically coupled with the set of conductive lines in the module current collector 155 and the terminal ports of the terminal port structure 160 of the lid structure 155. The positive terminal of the battery module 145 can be electrically coupled with the positive polarity port of the terminal port structure 160 via the positive terminal conductive line of the module current collector 155. The negative terminal of the battery module 145 can be electrically coupled with the negative polarity port of the terminal port structure 160 via the negative terminal conductive line of the module current collector 155.

Below the housing 110 for the battery pack 105, the apparatus 100 can include at least one cold plate 165. The cold plate 165 can be arranged or disposed along a bottom surface of the bottom panel 115. The cold plate 165 can be fluidly coupled with the inlet 120 and the outlet 130 and with the housing 110 to circulate the coolant through the cold plate 165. The cold plate 165 can be thermally coupled with the set of battery modules 145 through the bottom panel 115. The cold plate 165 can be comprised of a thermally conductive material. The thermally conductive material for the cold plate 165 can include a ceramic material (e.g., silicon nitride, silicon carbide, titanium carbide, zirconium dioxide, and beryllium oxide), a metal (e.g., aluminum, copper, iron, tin, lead, and various alloys), and a thermoplastic material (e.g., acrylic glass, polyethylene, polypropylene, polystyrene, or polyvinyl chloride), among others. The cold plate 165 can be mechanically coupled with the bottom panel 115 forming the bottom longitudinal side of the housing 110. The bottom panel 115 can be supported or can rest on at least a portion of the top surface of the cold plate 165. The cold plate 165 can be of various shapes. The shape of the cold plate 165 can match at least a portion of the shape of the bottom longitudinal side of the housing 110 (e.g., the bottom panel 115). The shape of the cold plate 165 can be polygonal, triangle, a square, a rectangle (e.g., as depicted), a pentagon, or a hexagon, among others. The shape of the cold plate 165 can be circular, such as a circle or oval. The dimensions of the cold plate 165 can substantially match (e.g., within 10% deviation) the dimensions of the bottom panel 115. The cold plate 165 can have a length ranging between 1711 mm to 2111 mm. The cold plate 165 can have a width ranging between 1110 mm to 1510 mm. The cold plate 165 can have a thickness ranging between 2.2 mm to 10.2 mm.

The apparatus 100 can also include at least one sealing element 170. The sealing element 170 can be disposed or arranged between the cold plate 165 and the bottom panel 115 for the battery pack 105. The sealing element 170 can be disposed or arranged at least partially along a perimeter region of a top surface of the cold plate 165. The sealing element 170 can be disposed or arranged at least partially along a perimeter region of the bottom surface of the bottom panel 115. The sealing element 170 can mechanically couple the cold plate 165 with the bottom panel 115 for the battery pack 105. The mechanical coupling between the cold plate 165 with the bottom panel 115 can be a seal, such as a mechanical seal, such as a hermetic seal, an induction seal, a hydrostatic seal, a hydrodynamic seal, and a bonded seal, among others. The sealing element 170 can secure or hold the cold plate 165 against the bottom panel 115 for the battery pack 105. Via the mechanical coupling between the cold plate 165 with the bottom panel 115, the sealing element 170 can maintain or retain the coolant within the cold plate 165. The sealing element 170 can define an opening (e.g., as depicted) within an interior portion. The opening can span from one longitudinal side (e.g., a top side) to an opposite longitudinal side (e.g., bottom side) of the sealing element 170. The sealing element 170 can be of any shape. An outer shape of the sealing element 170 can match the shape of the bottom panel 115. The shape of the sealing element 170 and the opening within the sealing element 170 can be a polygon, such as a triangle, a square, a rectangle (e.g., as depicted), a pentagon, or a hexagon, among others. The shape of the sealing element 170 and the opening within the sealing element 170 can be circular, such as a circle or oval. The dimensions of the sealing element 170 can substantially match (e.g., within 10% deviation) the dimensions of the bottom panel 115 or the top surface of the cold plate 165. The sealing element 170 can have a length ranging between 1671 mm to 2071 mm. The opening defined within the sealing element 170 can have a length ranging between 1651 mm to 2051 mm. The sealing element 170 can have a width ranging between 1070 mm to 1470 mm. The opening defined within the sealing element 170 can have a width ranging between 1050 mm to 1450 mm. The sealing element 170 can have a thickness ranging between 0.5 mm to 9.2 mm.

The apparatus 100 can include at least one cover element 175. The cover element 175 can be disposed or arranged beneath a bottom surface of the cold plate 165. The cover element 175 can mechanically couple with the bottom surface of the bottom panel 115 for the battery pack 105. The mechanical coupling between the cover element 175 and the bottom surface of the bottom panel 115 can secure or hold the cold plate 165 and the sealing element 170 against the bottom surface of the bottom panel 115. The mechanical coupling between the cover element 175 and the bottom surface of the bottom panel 115 can be with a set of fasteners, such as screws, bolts, clasps, buckets, ties, or clips, among others. The set of fasteners can be located or situated along an outer perimeter region of the cover element 175. The cover element 175 can be comprised of a thermally conductive material. The thermally conductive material for the cover element 175 can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others. The cover element 175 can be of any shape. The cover element 175 can be of various shapes. The shape of the cover element 175 can match at least a portion of the shape of the bottom longitudinal side of the housing 110 (e.g., the bottom panel 115). The shape of the cover element 175 can be a polygonal, such as a triangle, a square, a rectangle (e.g., as depicted), a pentagon, or a hexagon, among others. The shape of the cover element 175 can be circular, such as a circle or oval. The dimensions of the cover element 175 can substantially match (e.g., within 10% deviation) the dimensions of the bottom panel 115 or the cold plate 165. The cover element 175 can have a length ranging between 1741 mm to 2141 mm. The cover element 175 can have a width ranging between 1175 mm to 175 mm. The cover element 175 can have a thickness ranging between 1 mm to 8 mm.

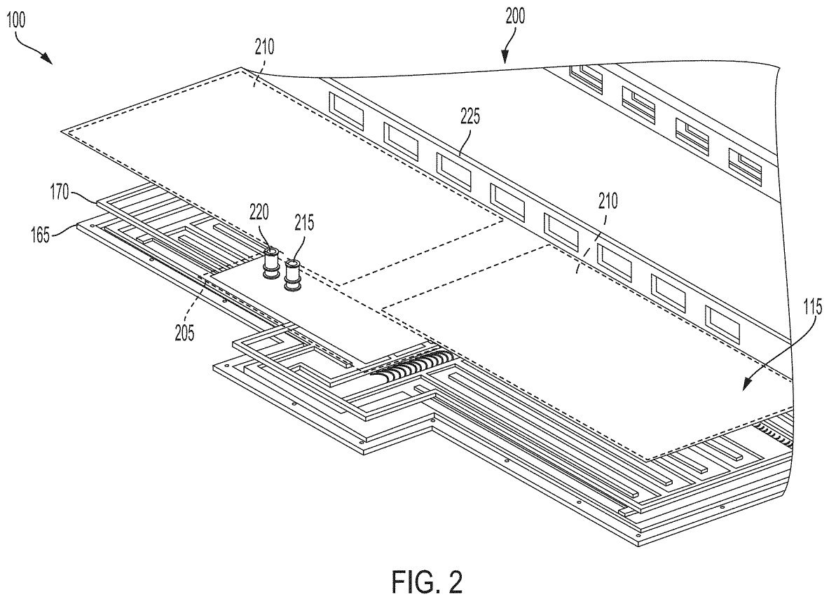

FIG. 2, among others, depicts an isometric view of the apparatus 100 for powering electric vehicles. The side walls (e.g., the first side wall 120 and the second side wall 125) and the bottom panel 115 of housing 110 can define a cavity 200 within the housing 110. The cavity 200 can correspond to an opening within the housing 110 spanning within the longitudinal sides and the lateral sides of the housing 110 for the battery pack 105. Within the cavity 200, the bottom panel 115 can define or have at least one connector region 205. The connector region 205 can correspond to a portion of the bottom panel 115 on an underside of the support structure 130. The connector region 250 can be vertically aligned with the support structure 130. The connector region 205 can correspond to the portion of the bottom panel 115 toward the support structure 130 situated on the first side wall 120. The connector region 205 can correspond to the portion of the bottom panel 115 toward the support structure 130 situated on the second side wall 125. At least a portion of the connector region 205 can protrude out (e.g., as depicted) from a remaining portion of the bottom panel 115. The connector region 205 can be separate from the bottom panel 115, and can be connected or attached to the bottom panel 115. The support structure 130 can be supported by, can be connected to, or otherwise can rest on the connector region 205 of the bottom panel 115. The connector region 205 can be of any shape. The shape of the connector region 205 can match the shape of the support structure 130. The shape of the connector region 205 can be a polygon, such as a triangle, a square, a rectangle (e.g., as depicted), a pentagon, or a hexagon, among others. The shape of the connector region 205 can be circular, such as a circle or oval. The connector region 205 can have a length ranging between 350 mm to 390 mm. The connector region 205 can have a width ranging between 80 mm to 120 mm.

The bottom panel 115 can define or have a set of support regions 210. The set of support regions 210 can be defined in parallel on the top surface 300 of the cold plate 165. Each support region 210 can correspond to an area on a top surface of the bottom panel 115 that can support at least one battery module 145. Each battery module 145 of the battery pack 105 can be supported or rest on one of the support regions 210 defined on the bottom panel 115. A bottom surface of the battery module 145 can be at least partially flush or in contact with the top surface of the bottom panel 115 within the support region 210. Each battery module 145 of the battery pack 105 can be mechanically coupled with the top surface of the bottom panel 115 within the support region 210. Each support region 210 can be in direct physical contact with the bottom surface of the corresponding battery module 145. Each support region 210 can be thermally coupled with the bottom surface of the corresponding battery module 145. The support region 210 can be of any shape. The shape of the support region 210 can match the bottom surface of the battery module 145. The shape of the support region 210 can be a polygon, such as a triangle, a square, a rectangle (e.g., as depicted), a pentagon, or a hexagon, among others. The shape of the support region 210 can be circular, such as a circle or oval. The support region 210 can have a length ranging between 603 mm to 663 mm. The support region 210 can have a width ranging between 308 mm to 368 mm.

The apparatus 100 can include at least one inlet port 215. The inlet port 215 can be defined through the top surface and the bottom surface of the bottom panel 115. The inlet port 215 can be defined through the bottom panel 115 within the connector region 205. The inlet port 215 can span from above the top surface of the bottom panel 115 (e.g., as depicted). The inlet port 215 can span beneath the bottom surface of the bottom panel 115. The inlet port 215 can receive the coolant from outside the housing 110. The inlet port 215 can be fluidly coupled with the inlet 130 to receive the coolant from the outside the housing 110. The inlet port 215 can be fluidly coupled with the source external to the housing 110 via the inlet 130. The inlet port 215 can be fluidly coupled with the external source through the inlet 130 via a pressure regulator. The pressure regulator can control an intake flow rate of the coolant fed into the housing 110 via the inlet 130 and the inlet port 215. The pressure regulator can include a loading element to apply pressure to the coolant fed into the housing 110 via the inlet 130 and the inlet port 215. The inlet port 215 itself can also include an inlet control valve to control the intake flow rate on the inlet port 215. The inlet control valve of the inlet port 215 can include an actuator and a restrictive member controlled by the actuator to set the intake flow rate. The inlet port 215 can be of any shape. The shape of the inlet port 215 can be prism with a polygonal base, such as a triangle, a square, a rectangular, a pentagon, or a hexagon, among others. The inlet port 215 can be a cylinder with a circular (e.g., as depicted), ovular, or elliptical base, among other. The inlet port 215 can have a length ranging between 30 mm to 50 mm. The inlet port 215 can have a width (or a diameter in circular examples) ranging between 9 mm to 29 mm. The inlet port 215 can have a height ranging between 9 mm to 29 mm.

The apparatus 100 can include at least one outlet port 220. The outlet port 220 can be defined through the top surface and the bottom surface of the bottom panel 115. The outlet port 220 can be defined through the bottom panel 115 within the connector region 205. The outlet port 220 can span from above the top surface of the bottom panel 115 (e.g., as depicted). The outlet port 220 can span beneath the bottom surface of the bottom panel 115. The outlet port 220 can release the coolant from within the housing 110. The outlet port 220 can be fluidly coupled with the outlet 135 to release or drain the coolant from within the housing 110. The outlet port 220 can be fluidly coupled via the outlet 135 with a disposal external to the housing 110 to receive the coolant. The disposal can include a fluid tank containing or holding the coolant, and can be the same fluid tank as the source feeding the coolant to the housing 110 via the inlet port 215. The outlet port 220 can be fluidly coupled with the external source via a pressure regulator. The pressure regulator can control an outtake flow rate of the coolant released from the housing 110 via the outlet 135 and the outlet port 220. The pressure regulator can include a loading element to apply pressure to the coolant drained from the housing 110 via the outlet 135 and the outlet port 220. The outlet port 220 itself can also include an outlet control valve to control the outtake flow rate on the outlet port 220. The outlet control valve of the outlet port 220 can include an actuator and a restrictive member controlled by the actuator to set the outtake flow rate. The outlet port 220 can be of any shape. The shape of the outlet port 220 can be prism with a polygonal base, such as a triangle, a square, a rectangular, a pentagon, or a hexagon, among others. The outlet port 220 can be a cylinder with a circular (e.g., as depicted), ovular, or elliptical base, among other. The outlet port 220 can have a length ranging between 30 mm to 50 mm. The outlet port 220 can have a width (or a diameter in circular examples) ranging between 9 mm to 29 mm. The outlet port 220 can have a height ranging between 9 mm to 29 mm.

The fluid coupling between the inlet 130 and the inlet port 215 can be via a fluid conduit (e.g., a pipe). The fluid coupling between the outlet 135 and the outlet port 220 can also be via a fluid conduit (e.g., a pipe). The fluid conduit between the inlet 130 and the inlet port 215 can include a set of segments. The fluid conduit between the outlet 135 and the outlet port 220 can include a set of segments. One end of one segment can be attached, sealed, or otherwise joined to one end of another segment. A length of the fluid conduit can be less than the length of the side wall 120 on which the support structure 130 is situated. The length of the fluid conduit between the inlet 130 and the inlet port 215 can range between 110 mm to 150 mm. The length of the fluid conduit between the outlet 135 and the outlet port 220 can range between 125 mm to 165 mm. The length of the fluid conduit between the inlet 130 and the inlet port 215 can differ from the length of the fluid conduit between the outlet 135 and the outlet port 220, and vice-versa. The fluid conduit between the inlet 130 and the inlet port 215 can have a width (or a diameter) ranging between 8 mm to 28 mm. The fluid conduit between the outlet 135 and the outlet port 220 can have a width (or a diameter) ranging between 8 mm to 28 mm. In this manner, the use of pipes to convey the coolant through the apparatus 100 can be restricted to one area of the housing 110.

The apparatus 100 can include a set of divider elements 225. The set of divider elements 225 can include at least one widthwise divider element (e.g., as depicted). The divider element 225 can divide the cavity 200 along a width of the housing 110 (e.g., as depicted) into at least two portions. The divider element 225 can divide the cavity 200 along a length of the housing 110 into at least two portions. The divider element 225 can divide subsets of support regions 210 from one another. The divider element 225 can partition the cavity 200 into multiple portions. Each portion of the cavity 200 defined by the divider element 225 can house or contain at least one of the battery modules 145. Each divider element 225 can be arranged between a lateral surface of one battery module 145 and an opposing lateral surface of another battery module 145. The divider element 225 can at least partially extend from the bottom panel 205 of the housing 110. The divider element 225 can extend or span the cavity 200 from one lengthwise side wall to the opposing lengthwise side wall of the housing 110. The divider element 225 can be substantially orthogonal (e.g., ranging between 85° to 95°) with one of the side walls. The divider element 225 can substantially parallel (e.g., deviation of 15%) with one of the side walls (e.g., the side wall 120). Within the cavity 200, each portion defined by the divider element 225 can contain, house, or otherwise include at least one battery modules 145, among others. A lateral surface of the divider element 225 can be in contact or flush with a lateral surface of the battery module 145. The divider element 225 can be supported by the bottom panel 115. A length of the divider element 225 can be the length of the cavity 200 defined within the housing 110, and can range between 1166 mm to 1566 mm. A height of the divider element 225 can be the height of the cavity 200 defined within the housing 110, and can range between 45 mm to 65 mm. A width of the divider element 225 can range between 10 mm to 20 mm.

The set of divider elements 225 can include at least one lengthwise divider element. The lengthwise divider element can span substantially orthogonally (e.g., within 15% deviation) with at least one of the widthwise divider elements. The divider element 225 can divide the cavity 200 along a long side into at least two portions. The divider element 225 can divide subsets of support regions 210 from one another. The divider element 225 can at least partially extend from the bottom panel 115. The divider element 225 can extend or span the cavity 200 from one widthwise side wall (e.g., the side wall 120) to an opposing widthwise side wall of the housing 110. The divider element 225 can be substantially orthogonal (e.g., ranging between 85° to 95°) with the second side wall 120 or the fourth side wall 135. The divider element 225 can substantially parallel (e.g., deviation of 15%) with one widthwise side wall (e.g., the side wall 120) or an opposing widthwise side wall of the housing 110. Within the cavity, each portion defined by the divider element 225 can contain, house, or otherwise include at least one battery modules 145, among others. A lateral surface of the divider element 225 can be in contact or flush with a lateral surface of the battery module 145. The divider element 225 can be supported by the bottom panel 115. A length of the divider element 225 can be the width of the cavity 200 defined within the housing 110, and can range between 1166 mm to 1566 mm. A height of the divider element 225 can be the height of the cavity 200 defined within the housing 110, and can range between 35 mm to 75 mm. A width of the divider element 225 can range between 5 mm to 25 mm.

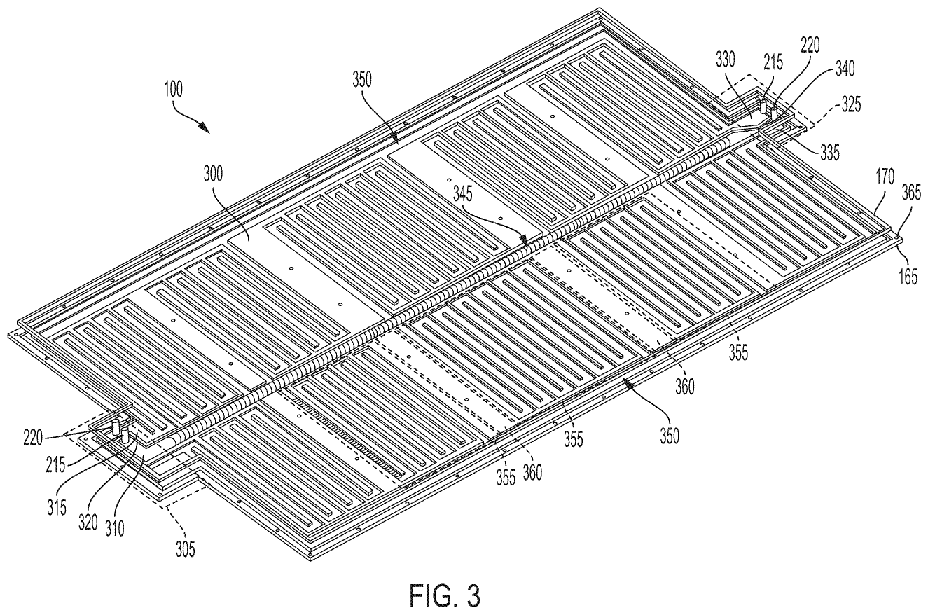

FIG. 3, among others, depicts an isometric view of a top surface 300 of the cold plate 165 and the sealing element 170 of the apparatus 100 for powering electric vehicles. The top surface 300 of the cold plate 165 can correspond to a top longitudinal side of the cold plate 165. The top surface 300 of the cold plate 165 can be the side facing the bottom surface of the bottom panel 115 for the battery pack 105. As illustrated, the cold plate 165 can define or have at least one collector area 305 (sometimes referred herein a frontside collector area). The collector area 305 can correspond to a portion of the bottom panel 115. At least a portion of the collector area 305 can correspond to a portion of the cold plate 165 vertically aligned with the support structure 130 situated on the first side wall 120. At least a portion of the collector area 305 can protrude out (e.g., as depicted) from a remaining portion of the cold plate 165. For example, as illustrated, the collector area 305 can protrude out from a front lateral side of the cold plate 165. The collector area 305 can be of any shape. The shape of the collector area 305 can be polygonal, such as a triangle, a square, a rectangle (e.g., as depicted), a pentagon, or a hexagon, among others. The shape of the collector area 305 can be circular, such as a circle or oval. The collector area 305 can have a length ranging between 330 mm to 370 mm. The collector area 305 can have a width ranging between 110 mm to 150 mm.

On the top surface 300 of the collector area 305, the cold plate 165 can define or have at least one intake area 310. The intake area 310 can correspond to a depression partially extending from the top surface 300 into the cold plate 165. The intake area 310 can receive the coolant from outside the housing 110 via the inlet 135 through the inlet port 215. The intake area 310 can be fluidly coupled with the inlet port 215 defined through the bottom panel 115 to receive the coolant into the cold plate 165. The intake area 310 can be vertically aligned with the inlet port 215 defined through the bottom panel 115 (e.g., by the first wall 120). For example, as depicted, the inlet port 215 can be positioned above the intake area 310 defined on the top surface 300 of the cold plate 165. The depression corresponding to the intake area 310 can be of any shape. The shape of the intake area 310 can be any shape. The shape of the intake area 310 can be a polygon, such as a triangle, a square, a rectangle (e.g., as depicted), a pentagon, or a hexagon, among others. The shape of the intake area 310 can be circular, such as a circle or oval, among others. The intake area 310 can have a length ranging between 80 mm to 120 mm. The intake area 310 can have a width ranging between 86 mm to 126 mm. The intake area 310 can have a depth ranging between 2 mm to 8 mm. The bottom end of the inlet port 215 can be in contact with the intake area 310. The bottom end of the inlet port 215 can be separated from the intake area 310. A space between the intake area 310 and the bottom end of the inlet port 215 can range between 2 mm to 8 mm.

The cold plate 165 can define or have at least one outtake area 315 along the top surface 300 of the collector area 305. The outtake area 315 can correspond to a depression partially extending from the top surface 300 into the cold plate 165. The outtake area 315 can be adjacent to the intake area 310 (e.g., as depicted). The outtake area 315 can be separated from the outtake area 310. The outtake area 315 can release or drain the coolant from within the cold plate 165 via the outlet port 220 via the outlet 140. The outtake area 315 can be fluidly coupled with the outlet port 220 defined through the bottom panel 115 to release the coolant from the cold plate 165. The outtake area 315 can be vertically aligned with the outlet port 220 defined through the bottom panel 115 (e.g., by the first wall 120). For example, as depicted, the outlet port 220 can be positioned above the outtake area 315 defined on the top surface 300 of the cold plate 165. The depression corresponding to the outtake area 315 can be of any shape. The shape of the outtake area 315 can be any shape. The shape of the outtake area 315 can be a polygon, such as a triangle, a square, a rectangle (e.g., as depicted), a pentagon, or a hexagon, among others. The shape of the outtake area 315 can be circular, such as a circle or oval, among others. The shape of the outtake area 315 can differ from the shape of the intake area 310. The outtake area 315 can have a length ranging between 100 mm to 140 mm. The outtake area 315 can have a width ranging between 13.5 mm to 33.5 mm. The outtake area 315 can have a depth ranging between 2 mm to 8 mm. The dimensions of the outtake area 315 can differ from the dimensions of the intake area 310. The bottom end of the outlet port 220 can be in contact with the outtake area 315. The bottom end of the outlet port 220 can be separated from the outtake area 315. A space between the outtake area 315 and the bottom end of the outlet port 220 can range between 2 mm to 8 mm.

The cold plate 165 can define or have at least one separator element 320 between the intake area 310 and the outtake area 315. The separator element 320 can correspond to a portion of the top surface 300. The separator element 320 can correspond to a structure (e.g., a wall as depicted) spanning from the bottom surface of the intake area 310 or the outtake area 315. The separator element 320 can divide the intake area 310 from the outtake area 315, and vice-versa. The separator element 320 can maintain the coolant received from the inlet port 215 in the intake area 310. The separator element 320 can maintain the coolant to be released from the coolant in the outtake area 315. The separator element 320 can divide the coolant retained in the intake area 310 from the coolant in the outtake area 315. The shape of the separator element 320 can be any shape. The shape of the separator element 320 can be a polygon, such as a triangle, a square, a rectangle (e.g., as depicted), a pentagon, or a hexagon, among others. The shape of the separator element 320 can be circular, such as a circle or oval, among others. The separator element 320 can have a length ranging between 120 mm to 160 mm. The separator element 320 can have a width ranging between 8 mm to 12 mm. The separator element 320 can have a depth ranging between 2 mm to 8 mm.

The cold plate 165 can define or have at least one collector area 325 (sometimes referred herein a backside collector area). The collector area 325 can correspond to a portion of the bottom panel 115. At least a portion of the collector area 325 can correspond to a portion of the cold plate 165 vertically aligned with the support structure 130 situated on the second side wall 125. At least a portion of the collector area 325 can protrude out (e.g., as depicted) from a remaining portion of the cold plate 165. The collector area 325 can be on an opposite side of the collector area 305 on the cold plate 165. For example, as shown, the collector area 325 can protrude from a rear lateral side of the cold plate 165, whereas the collector area 305 can protrude from the front lateral side of the cold plate 165. The collector area 325 can be of any shape. The shape of the collector area 325 can be polygonal, triangle, a square, a rectangle (e.g., as depicted), a pentagon, or a hexagon, among others. The shape of the collector area 325 can be circular, such as a circle or oval. The dimensions of the collector area 325 can differ from the dimensions of the collector area 305. The collector area 325 can have a length ranging between 180 mm to 220m. The collector area 325 can have a width ranging between 80 mm to 120 mm.

On the top surface 300 of the collector area 325, the cold plate 165 can define or have at least one intake area 330. The intake area 330 can correspond to a depression partially extending from the top surface 300 into the cold plate 165. The intake area 330 can receive the coolant from outside the housing 110 via the inlet 135 through the inlet port 215. The intake area 330 can be fluidly coupled with the inlet port 215 defined through the bottom panel 115 to receive the coolant into the cold plate 165. The intake area 330 can be vertically aligned with the inlet port 215 defined through the bottom panel 115 (e.g., by the second wall 125). For example, as depicted, the inlet port 215 can be positioned above the intake area 330 defined on the top surface 300 of the cold plate 165. The depression corresponding to the intake area 330 can be of any shape. The shape of the intake area 330 can be any shape. The shape of the intake area 330 can be a polygon, such as a triangle, a square, a rectangle (e.g., as depicted), a pentagon, or a hexagon, among others. The shape of the intake area 330 can be circular, such as a circle or oval, among others. The intake area 330 can have a length ranging between 76 mm to 106 mm. The intake area 330 can have a width ranging between 35 mm to 75 mm. The intake area 330 can have a depth ranging between 2 mm to 8 mm. The bottom end of the inlet port 215 can be in contact with the intake area 330. The bottom end of the inlet port 215 can be separated from the intake area 330. A space between the intake area 330 and the bottom end of the inlet port 215 can range between 2 mm to 8 mm.

The cold plate 165 can define or have at least one outtake area 335 along the top surface 300 of the collector area 325. The outtake area 335 can correspond to a depression or a channel partially extending from the top surface 300 into the cold plate 165. The outtake area 335 can be adjacent to the intake area 330 (e.g., as depicted). The outtake area 335 can be separated from the outtake area 310. The outtake area 335 can release or drain the coolant from within the cold plate 165 via the outlet port 220 via the outlet 140. The outtake area 335 can be fluidly coupled with the outlet port 220 defined through the bottom panel 115 to release the coolant from the cold plate 165. The outtake area 335 can be vertically aligned with the outlet port 220 defined through the bottom panel 115 (e.g., by the second wall 125). For example, as depicted, the outlet port 220 can be positioned above the outtake area 335 defined on the top surface 300 of the cold plate 165. The depression corresponding to the outtake area 335 can be of any shape. The shape of the outtake area 335 can be any shape. The shape of the outtake area 335 can be a polygon, such as a triangle, a square, a rectangle (e.g., as depicted), a pentagon, or a hexagon, among others. The shape of the outtake area 335 can be circular, such as a circle or oval, among others. The shape of the outtake area 335 can differ from the shape of the intake area 330. The outtake area 335 can have a length ranging between 63 mm to 103 mm. The outtake area 335 can have a width ranging between 10 mm to 30 mm. The outtake area 335 can have a depth ranging between 2 mm to 8 mm. The dimensions of the outtake area 335 can differ from the dimensions of the intake area 330. The bottom end of the outlet port 220 can be in contact with the outtake area 335. The bottom end of the outlet port 220 can be separated from the outtake area 335. A space between the outtake area 335 and the bottom end of the outlet port 220 can range between 2 mm to 8 mm.

The cold plate 165 can define or have at least one separator element 340 between the intake area 330 and the outtake area 335. The separator element 340 can correspond to a portion of the top surface 300. The separator element 340 can correspond to a structure (e.g., a wall as depicted) spanning from the bottom surface of the intake area 330 or the outtake area 335. The separator element 340 can divide the intake area 330 from the outtake area 335, and vice-versa. The separator element 340 can maintain the coolant received from the inlet port 215 in the intake area 330. The separator element 340 can maintain the coolant to be released from the coolant in the outtake area 335. The separator element 340 can divide the coolant retained in the intake area 330 from the coolant in the outtake area 335. The shape of the separator element 340 can be any shape. The shape of the separator element 340 can be a polygon, such as a triangle, a square, a rectangle (e.g., as depicted), a pentagon, or a hexagon, among others. The shape of the separator element 340 can be circular, such as a circle or oval, among others. The separator element 340 can have a length ranging between 78 mm to 118 mm. The separator element 340 can have a width ranging between 5 mm to 15 mm. The separator element 340 can have a depth ranging between 2 mm to 8 mm.

Along the top surface 300, the cold plate 165 can define or have at least one main intake channel 345. The main intake channel 345 can correspond to a depression, a trench, a divot, or trough defined spanning the top surface 300 of the cold plate 165. The main intake channel 345 can have an initial end and a terminal end. The main intake channel 345 can convey the coolant received into the cold plate 165 along the top surface 300 from the initial end to the terminal end. On the initial end, the main intake channel 345 can extend along the top surface 300 starting from the intake area 310. The initial end can correspond to an intake point within the intake area 310. The main intake channel 345 can be fluidly coupled with the inlet 135 on the housing 110 and the inlet port 215 defined through the bottom panel 115 via the intake area 310 on the collector area 305. Fluidly coupled with the inlet 135 and the inlet port 215 via the intake area 310, the main intake channel 345 can receive the coolant from outside the cold plate 165. From the intake area 310, the main intake channel 345 can convey the coolant across the top surface 300 of the cold plate 165. On the terminal end, the main intake channel 345 can extend along the top surface 300 can be fluidly coupled with the outlet 140 on the housing 110 and the outlet port 220 defined through the bottom panel 115 via the intake area 335 of the collector area 325. Fluidly coupled with the outlet 140 and the outlet port 220 via the outtake area 335, the main intake channel 345 can release the coolant from the cold plate 165. The main intake channel 345 can also be fluidly coupled with a return on the terminal end. The return can be fluidly coupled with the outtake area 315 defined in the collector area 305 same as the intake area 310. Fluidly coupled with the return, the main intake channel 345 can convey the coolant via the return to the outtake area 315. The main intake channel 345 can also release the coolant from the cold plate 165 via the return through the outtake area 315, the outlet port 220, and the outlet 140.

The spanning of the main intake channel 345 along the top surface 300 of the cold plate 165 can be a path of any direction, such as straight, circuitous, meandering, serpentine, winding, or zigzagging, among others or any combination thereof. At least a portion of the main intake channel 345 can span across an interior region of the top surface 300 of the cold plate 165. The interior portion can generally correspond to a central region of the top surface 300 of the cold plate 165. For example, at depicted, the main intake channel 345 can extend along a midline along the top surface 300 of the cold plate 165 (e.g., as depicted) from one widthwise edge to an opposing widthwise edge. The main intake channel 345 can extend along the interior region of the top surface 300 in a path substantially parallel (e.g., within 15% deviation) to at least one edge (e.g., a lengthwise edge as depicted) of the cold plate 165. The main intake channel 345 can extend along the interior region of the top surface 300 in a path substantially orthogonal (e.g., within 15% deviation) at least one edge (e.g., a widthwise edge as depicted) of the cold plate 165. At least a portion of the main intake channel 345 can span across an outer region of the top surface 300 of the cold plate 165. The outer region can generally correspond to the edges defining a perimeter of the cold plate 165. The depression into the top surface 300 corresponding to the main intake channel 345 can be of any shape. The depression can be a prismatic hollowing with a triangular, rectangular (e.g., as depicted), pentagonal, elliptical, and circular base, among other shapes. The main intake channel 345 can have a length ranging between 1818 mm to 2218 mm. The main intake channel 345 can have a width ranging between 30 mm to 70 mm. The main intake channel 345 can have a depth ranging between 2 mm to 8 mm.

The cold plate 165 can define or have at least one main outtake channel 350 on the top surface 300. The main outtake channel 350 can correspond to a depression, a trench, a divot, or trough defined spanning the top surface 300 of the cold plate 165. The main outtake channel 350 can have an initial end and a terminal end. The main outtake channel 350 can convey the coolant along the top surface 300 of the cold plate 165 from the initial end to the terminal end to release the coolant from the cold plate 165. On the terminal end, the main outtake channel can extend along the top surface 300 terminating into the outtake area 315. The terminal end can correspond to an outtake point within the outtake area 315. The main outtake channel 350 can be fluidly coupled with the outlet 140 on the housing 110 and the outlet port 220 defined through the bottom panel 115 via the outtake area 315 on the collector area 305. Fluidly coupled with the outlet 140 and the outlet port 220 via the outtake area 315, the main outtake channel 350 can drain or release the coolant from the cold plate 165. On the initial end, the main outtake channel 350 can the main outtake channel 350 can extend along the top surface 300 can be fluidly coupled with the inlet 135 on the housing 110 and the inlet port 215 defined through the bottom panel 115 via the intake area 330 of the collector area 325. Fluidly coupled with the inlet 135 and the inlet port 220 via the intake area 330, the main outtake channel 350 can receive the coolant into the cold plate 165. The main outtake channel 350 can convey the coolant across the top surface 300 and into the outtake area 315. The main outtake channel 350 can also be fluidly coupled with a return on the initial end. The return can connect the terminal end of the main intake channel 345 with the terminal end of the main outtake channel 350. The return can be fluidly coupled with the intake area 310 defined in the collector area 305 same as the outtake area 315. Fluidly coupled with the return, the main outtake channel 350 can convey the coolant from the intake area 310 via the return. The main outtake channel 350 can receive the coolant via the return from the inlet 135, the inlet port 215, and the intake area 310.

The spanning of the main outtake channel 350 along the top surface 300 of the cold plate 165 can be a path of any direction, such as straight, circuitous, meandering, serpentine, winding, or zigzagging, among others, or any combination thereof. At least a portion of the main outtake channel 350 can span across an interior region of the top surface 300 of the cold plate 165. The interior portion can generally correspond to a central region of the top surface 300 of the cold plate 165. At least a portion of the main outtake channel 350 can span across an outer region of the top surface 300 of the cold plate 165. The outer region can generally correspond to the edges defining a perimeter of the cold plate 165. For example, the main outtake channel 350 can extend along the perimeter region of the top surface 300 of along four edges of the cold plate 165 (e.g., as depicted). The main outtake channel 350 can extend along the perimeter region of the top surface 300 in a path substantially parallel (e.g., within 15% deviation) to least one edge of the cold plate 165. The edges along which the main outtake channel 350 can include at least one lengthwise edge or at least one widthwise edge, or both. The main outtake channel 350 can also extend along the top surface 300 of the cold plate 165 in the path of the main intake channel 345, and vice-versa. The depression into the top surface 300 corresponding to the main outtake channel 350 can be of any shape. The depression can be a prismatic hollowing with a triangular, rectangular (e.g., as depicted), pentagonal, elliptical, and circular base, among other shapes. The main outtake channel 350 can have a length ranging between 1655 mm to 2055 mm. The main outtake channel 350 can have a width ranging between 30 mm to 70 mm. The main outtake channel 350 can have a depth ranging between 2 mm to 8 mm.

On the top surface 300, the cold plate 165 can define or have a set of module regions 355. The set of module regions 355 can be defined in parallel on the top surface 300 of the cold plate 165. Each module region 355 can span between the main intake channel 345 and the main outtake channel 350 along the top surface 300 of the cold plate 165. Each module region 355 can correspond to an area on the top surface 300 of the cold plate 165 at least partially, longitudinally (e.g., vertically) aligned with at least one of the battery modules 145 arranged in the housing 110. Each module region 355 defined on the cold plate 165 can be at least partially, longitudinally (e.g., vertically) aligned with at least one of the support regions 210 defined on the bottom panel 115. Each module region 355 can be at least partially flush with the bottom surface of the bottom panel 210 of the corresponding support region 210. For example, the module region 355 can be vertically aligned with a corresponding support region 210 above in the bottom panel 115 and with a corresponding battery module 145 arranged in the housing 110. Each module region 355 can be adjacent to the main intake channel 345 on one edge (e.g., toward the center of the cold plate 165 as depicted). Each module region 355 can be adjacent to the main outtake channel 350 on another edge (e.g., an opposing edge towards the perimeter of the cold plate 165 as depicted). Each module region 355 can be of any shape. The shape of each module region 355 can match the shape of the support region 210 or the bottom surface of the battery module 145. The shape of each module region 355 can be a polygon, such as a triangle, a square, a rectangle (e.g., as depicted), a pentagon, or a hexagon, among others. The shape of each module region 355 can be circular, such as a circle or oval. Each module region 355 can have a length ranging between 500 mm to 540 mm. Each module region 355 can have a width ranging between 226 mm to 266 mm.

Each module region 355 can be thermally coupled with at least one of the battery modules 145 via the bottom panel 115. Each module region 355 can be thermally coupled with the bottom surface of at least one of the battery modules 145 supported by the support region 210 of the bottom panel 115. Each module region 355 can be fluidly coupled with the main intake channel 345 and with the main outtake channel 350 to circulate the coolant along the top surface 300 of the cold plate 165 within the module region 355. The set of module regions 355 may lack or can be outside of the main intake channel 345 or the main outtake channel 350. By circulating the coolant, the module region 355 can transfer hear away from the battery module 145 thermally coupled with the top surface 300 of the cold plate 165 in the module region 355.

The cold plate 165 can define or have a set of divider regions 360 along the top surface 300. Each divider region 360 can correspond to an area of the top surface 300 of the cold plate 165 between at least two module regions 355, the main intake channel 345, and the main outtake channel 350. Each divider region 360 can be adjacent to the at least two module regions 355. Each divider region 360 can be not longitudinally (e.g., vertically) aligned with at least one of the battery modules 145 arranged in the housing 110 for the battery pack 105. Each divider region 360 can be not longitudinally (e.g., vertically) with at least one of the support regions 210 defined on the bottom panel 115. Each divider region 360 can be at least partially, longitudinally aligned with divider element 225 disposed in the housing 110. For example, each divider region 360 can at least partially, vertically aligned with the divider element 225 situated above the top surface 300 of the cold plate 165 in the housing 110. Each divider region 360 can be flush or in contact with the bottom surface of the bottom panel 115 of the battery pack 105. Each divider region 360 can be adjacent to the main intake channel 345 on one edge (e.g., toward the center of the cold plate 165 as depicted). Each divider region 360 can be adjacent to the main outtake channel 350 on another edge (e.g., an opposing edge towards the perimeter of the cold plate 165 as depicted). The set of divider regions 360 can be fluidly uncoupled from the main intake channel 345 and from the main outtake channel 350. Each divider region 360 can retain the coolant within the module region 355 adjacent to the divider region 360. Each divider region 360 can prevent the coolant from one module region 355 to another module region 355. Each divider region 360 can be of any shape. The shape of each divider region 360 can match the shape of the support region 210 or the bottom surface of the battery module 145. The shape of each divider region 360 can be a polygon, such as a triangle, a square, a rectangle (e.g., as depicted), a pentagon, or a hexagon, among others. The shape of each divider region 360 can be circular, such as a circle or oval. Each divider region 360 can have a length ranging between 525 mm to 565 mm. Each divider region 360 can have a width ranging between 34 mm to 74 mm.

The cold plate 165 can also define or have at least one attachment region 365 along the top surface 300. The attachment region 365 can be defined at least partially along the perimeter region of the top surface 300 of the cold plate 165. The attachment region 365 can correspond to a depression, a trench, a divot, or trough spanning the top surface 300 of the cold plate 165. The attachment region 365 can hold or contain at least a portion of the sealing element 170 into the cold plate 165. At least a portion of the sealing element 170 can be compressed or spread about the attachment region 365 defined on the top surface 300 of the cold plate 165. The attachment region 365 can mechanically couple the top surface 300 of the cold plate 165 to the bottom surface of the bottom panel 115 via the sealing element 170. The mechanical coupling with the attachment region 365 can a seal, such as a mechanical seal, such as a hermetic seal, an induction seal, a hydrostatic seal, a hydrodynamic seal, and a bonded seal, among others. The attachment region 365 can secure or hold the cold plate 165 against the bottom surface of the bottom panel 115 via the sealing element 170 held at least partially within the attachment region 365. The attachment region 365 can be secured or held against the bottom surface of the bottom panel 115 via the sealing element 170 using the cover element 175 disposed on the bottom surface of the cold plate 165.

The spanning of the attachment region 365 along the top surface 300 of the cold plate 165 can be a path of any direction, such as straight, circuitous, meandering, serpentine, winding, or zigzagging, among others, or any combination thereof. At least a portion of the attachment region 365 can span across an interior region of the top surface 300 of the cold plate 165. The interior portion can generally correspond to a central region of the top surface 300 of the cold plate 165. At least a portion of the attachment region 365 can span across an outer region of the top surface 300 of the cold plate 165. The outer region can generally correspond to the edges defining a perimeter of the cold plate 165. For example, the attachment region 365 can extend along the perimeter region of the top surface 300 of along four edges of the cold plate 165 (e.g., as depicted). The attachment region 365 can extend along the perimeter region of the top surface 300 in a path substantially parallel (e.g., within 15% deviation) to least one edge of the cold plate 165. The edges along which the attachment region 365 extend can include at least one lengthwise edge or at least one widthwise edge, or both. The depression into the top surface 300 corresponding to the attachment region 365 can be of any shape. The depression can be a prismatic hollowing with a triangular, rectangular (e.g., as depicted), pentagonal, elliptical, and circular base, among other shapes. The attachment region 365 can have a length ranging between 525 mm to 565 mm. The attachment region 365 can have a width ranging between 80 mm to 120 mm. The attachment region 365 can have a depth ranging between 2 mm to 8 mm.

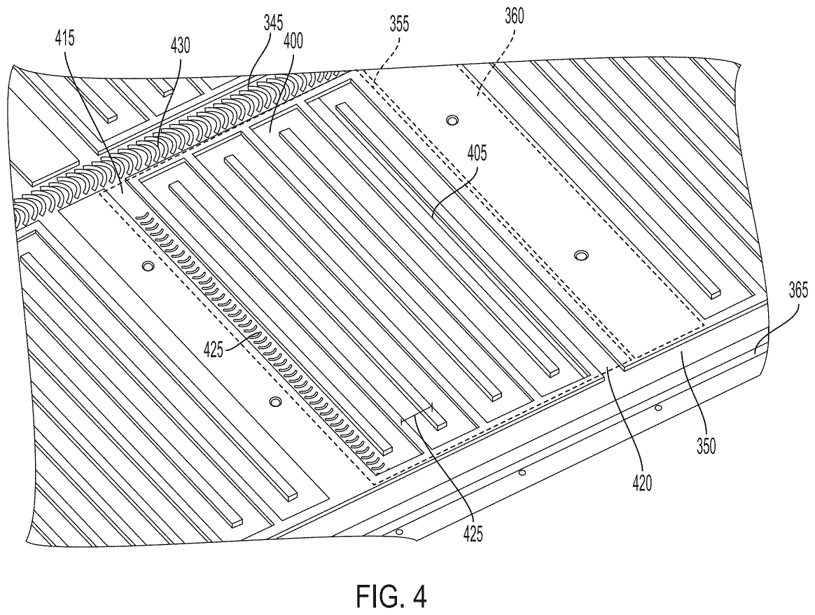

FIG. 4, among others, depicts a close-up isometric view of the cold plate 165 of the apparatus 100 for powering electric vehicles. As depicted, in each module region 355 of the cold plate 165, the cold plate 165 can define or have at least one module channel 400. The module channel 400 can span across the top surface 300 of the cold plate 165 within the module region 355. The module channel 400 can correspond to a depression, a trench, a divot, or trough defined spanning across the top surface 300 of the cold plate 165 within the module region 355. The depression into the top surface 300 of the cold plate 165 within the module region 355 corresponding to the module channel 400 can be of any shape. The depression corresponding to the module channel 400 can be a prismatic hollowing with a triangular, rectangular (e.g., as depicted), pentagonal, elliptical, and circular base, among other shapes. The module channel 400 can have a length 405 ranging between 475 mm to 505 mm. The module channel 400 can have a width 410 ranging between 17 mm to 27 mm. The module channel 400 can have a depth ranging between 2 mm to 8 mm.

The module channel 400 can span the top surface 300 of the cold plate 165 within the module region 355 between an ingress point 415 and an egress point 420. The ingress points 415 can correspond to a depression into the top surface 300 of the cold plate 145 connecting the module channel 400 with the main intake channel 345 to fluidly couple the module channel 400 with the main intake channel 345. The egress point 420 can correspond to into the top surface 300 of the cold plate 145 connecting the module channel 400 with the main outtake channel 350 to fluidly couple the module channel 400 with the main outtake channel 350. The ingress point 415 of the module channel 400 can be defined along at least a portion of one edge of the module region 355. The egress point 420 of the module channel 400 can be defined along at least a portion of one edge of the module region 355. The ingress point 415 can be defined along the same edge of the module region 355 as the egress point 420. The ingress point 415 and the egress point 420 can be defined along different edges of the module region 355. For example, as depicted, the ingress point 415 can be defined on an edge of the module region 355 toward the center of the cold plate 165, whereas the egress point 420 can be defined on an edge of the module region 355 on the perimeter region.

Defined on the top surface 300 of the cold plate 165 within the module region 355, the module channel 400 can meander, traverse, or otherwise span the top surface 300 in the module region 355. The path of the depression corresponding to the module channel 400 can be a path of any direction, such as straight, circuitous, meandering, serpentine, winding, or zigzagging (e.g., as depicted), among others or any combination thereof. The module channel 400 can include or can be formed by a set of segments. Each segment can correspond to a generally straight portion of the depression corresponding to the module channel 400 on the top surface 300 within the module region 355. An end of one lengthwise segment of the module channel 400 can be connected or coupled with one end of one widthwise segment of the module channel 400 at a substantially orthogonal angle (e.g., between 75° and 105°). Each lengthwise segment of the module channel 400 can be substantially parallel (e.g., within 15% deviation) with one another. At least one of the lengthwise segments of the module channel 400 can span along a lengthwise edge of a perimeter region of the module region 355 on the top surface 300 of the cold plate 165. The perimeter region can correspond to portions of the module region 355 generally along the edges. For example, as depicted, two of the lengthwise segments of the module 400 can span along opposing lengthwise edges of the perimeter region of the module region 355. At least one of the widthwise segments of the module channel 400 can span along a widthwise edge of a perimeter region of the module region 355 on the top surface 300 of the cold plate 165. For example, as depicted, four of the widthwise segments of the module 400 can span along both widthwise edges of the perimeter region of the module region 355.

The module channel 400 can define or have a set of ridges 425. The set of ridges 425 can be defined in at least one of the segments of the module channel 400. The set of ridges 425 can correspond to protrusions, bulges, or other marks along a conveyance surface of the module channel 400. At least one of the segments of the module channel 400 can have or define the set of ridges 425. For example, as depicted the lengthwise segment of the module channel 400 adjacent to the ingress point 415 can have the set of ridges 425. The set of ridges 425 can be defined in at least a portion of the segment of the module channel 400. The set of ridges 425 can regulate or control the flow rate of the coolant through the module channel 400 of the module region 355. The set of ridges 425 can change the state of the flow of the coolant from laminate to turbulent to allow for contact with the bottom panel 115 to evacuate heat from the set of batter modules 145. The set of ridges 425 can be inclined relative to the direction of flow to decrease the flow rate of the coolant through the module channel 400. The angle of inclination of the set of ridges 425 can range between 2° to 8°. The set of ridges 425 can be declined relative to the direction of flow to increase the flow rate of the coolant through the module channel 400. The angle of declination of the set of ridges 425 can range between 2° to 8°. The number of ridges 425 defined in the module channel 400 can range between 80 and 120. Each ridge 425 can be of any shape. Each ridge 425 can be triangular, rectangular, pentagonal, polygonal, circular (e.g., half-circle as depicted), ovular, elliptical, or any other shape. Each ridge 425 can have a length ranging between 475 mm to 505 mm. Each ridge 425 can have a width ranging between 8 mm to 12 mm. Each ridge 425 can have a depth relative to the surface of the module channel 400 ranging between 2 mm to 8 mm.

The main intake channel 345 (e.g., as depicted) or the main outtake channel 350 can also define or have a set or ridges 430. The set of ridges 430 can correspond to protrusions, bulges, or other marks along a conveyance surface of the main intake channel 345. The set of ridges 430 can be defined in at least a portion of the main intake channel 345 or the main outtake channel 350. The set of ridges 430 can regulate or control the flow rate of the coolant through the main intake channel 345 in distributing the coolant to each module region 355. The set of ridges 430 can be inclined relative to the direction of flow to decrease the flow rate of the coolant through the main intake channel 345 or the main outtake channel 350. The angle of inclination of the set of ridges 430 can range between 2° to 8°. The set of ridges 430 can be declined relative to the direction of flow to increase the flow rate of the coolant through the main intake channel 345. The angle of declination of the set of ridges 430 can range between 2° to 8°. The number of ridges 430 defined in the main intake channel 345 or the main outtake channel 350 can range between 80 and 120. Each ridge 430 can be of any shape. Each ridge 430 can be triangular, rectangular, pentagonal, polygonal, circular (e.g., half-circle as depicted), ovular, elliptical, or any other shape. Each ridge 430 can have a length ranging between 30 mm to 50 mm. Each ridge 430 can have a width ranging between 3 mm to 7 mm. Each ridge 430 can have a depth relative to the surface of the main intake channel 345 ranging between 2 mm to 8 mm.

Fluidly coupled with the main intake channel 345 and the main outtake channel 350, the module channel 400 can circulate the coolant within the module region 355. The main intake channel 345 can distribute or provide the coolant to the module channels 400 defined in the set of module regions 355 on the top surface 300 of the cold plate 165. The module channel 400 can receive the coolant from the main intake channel 345 via the ingress point 415. The module channel 400 can convey the coolant received from the main intake channel 345 via ingress point 415 to the segments forming the module channel 400. The module channel 400 can release the coolant to the main outtake channel 350 via the egress point 420. Thermally coupled with at least one of the battery modules 145 through the bottom panel 115, the module channel 400 can evacuate, remove, or otherwise transfer heat away from the battery module 145 using the coolant. The coolant in the module channel 400 can stream or flow from the main intake channel 340 through the module region 355 to the main outtake channel 350. As the coolant traverses the module channel 400, the coolant within the module channel 400 can absorb the heat from the battery module 145 arranged in the support region 210 of the bottom panel 115 above the module region 355. In this manner, the coolant can spread fairly evenly throughout the module region 355 from the ingress point 415 and the egress point 420 of the module channel 400, and can be conveyed across the top surface 300 of the cold plate 165. By spreading out the coolant, the heat from the battery module 145 arranged above the module region 355 can be spread over the module region 355 and be evacuated via the coolant.

The cold plate 165 can be a single, monolithic structure. All the channels into the top surface 300 (e.g., the main intake channel 345, the main outtake channel 355, and the module channels 400) can be formed from the monolithic structure of the cold plate 165. Furthermore, as the top surface 300 can be mechanically coupled with the bottom surface of the bottom panel 115 via the sealing element 170, the coolant can be held within a volume defined between the channels and the bottom surface. Since the channels can be formed from the single, monolithic structure of the cold plate 165 mechanically coupled with the bottom surface of the bottom panel 115 through the sealing element 170, the likelihood of coolant leakage can decrease.

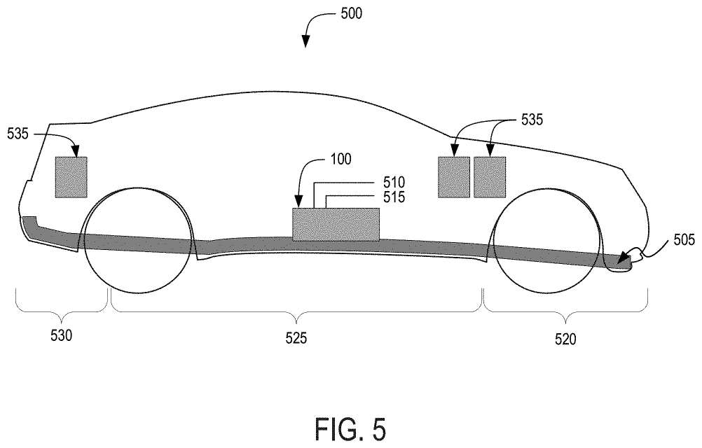

FIG. 5 depicts a cross-section view of an electric vehicle 500 installed with the apparatus 100. The electric vehicle 500 can be an electric automobile (e.g., as depicted), a motorcycle, a scooter, a passenger vehicle, a passenger or commercial truck, and another type of vehicle such as sea or air transport vehicles, a plane, a helicopter, a submarine, a boat, or a drone, among others. The electric vehicle 500 can include a chassis 505 (e.g., a frame, internal frame, or support structure). The chassis 505 can support various components of the electric vehicle 500. The chassis 505 can span a front portion 520 (e.g., a hood or bonnet portion), a body portion 525, and a rear portion 530 (e.g., a trunk portion) of the electric vehicle 500. The one or more battery packs 105 can be installed or placed within the electric vehicle 500. The one or more battery packs 105 can be installed on the chassis 505 of the electric vehicle 500 within the front portion 520, the body portion 525 (as depicted in FIG. 5), or the rear portion 530. The apparatus 100 can provide electrical power to one or more other components 535 (e.g., a motor, lights, radio, door, hood, or trunk opening, or other functionality) by electrically coupling with at least one positive current collector 510 (e.g., a positive busbar) and at least one negative current collector 515 (e.g., a negative busbar). The positive current collector 510 can be electrically coupled with the positive terminal of the apparatus 100 (e.g., through the terminal port structure of the lid structure 150). The negative current collector 515 can be electrically coupled with the negative terminal of the apparatus 100 (e.g., through the terminal port structure of the lid structure 150). The one or more components 535 can include an electric engine, an entertainment system (e.g., a radio, display screen, and sound system), on-board diagnostics system, and electric control units (ECUs) (e.g., an engine control module, a transmission control module, a brake control module, and a body control module), among others.

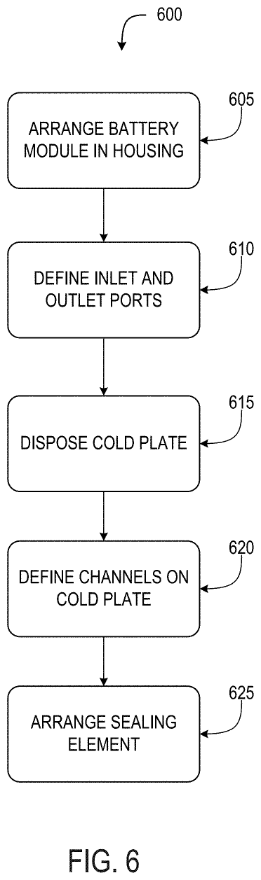

FIG. 6 depicts an example flow diagram for a method 600 of assembling a battery module for powering electric vehicles. The method 600 can be implemented using any of the components detailed herein in conjunction with FIGS. 1-5. The method 600 can include arranging a battery module 145 in a housing 110 (ACT 605). The battery module 145 can include a set of battery cells (e.g., lithium-based battery cells) to store electrical energy to power one or more components 535 of an electric vehicle 500. The housing 110 can include four lateral sides and two longitudinal side. The housing 110 can include a first side wall 120 and a second side wall 125 along two of the four lateral sides. The housing 110 can include a bottom panel 115 along a bottom longitudinal side. The lateral sides (including the first side wall 120 and the second side wall 125) and the bottom panel 115 can define a cavity 200 within the housing 110. A set of battery modules 145 can be inserted into the cavity 200 to rest upon at least a portion of the bottom panel 115. Each battery module 145 can be supported by at least a portion of a top surface 200 of the bottom panel 115.

The method 600 can include defining an inlet port 215 and an outlet port 220 (ACT 610). The inlet port 215 and the outlet port 220 can be defined through the bottom panel 115. The inlet port 215 and the outlet port 200 can be formed from the bottom panel 115 using various techniques, such as etching, stamping, braising, hydroforming, pressing, imprinting, and molding, among others. Both the inlet port 215 and the outlet port 220 can extend from above the top surface of the bottom panel 115 to below the bottom surface of the bottom panel 115. The inlet port 215 can be fluidly coupled (e.g., using a pipe) with a source outside the housing 110 to receive coolant into the housing 110. The outlet port 220 can be fluidly coupled (e.g., using a pipe) with a container outside the housing 110 to release the coolant from the housing 110.

The method 600 can include disposing a cold plate 165 (ACT 615). The cold plate 165 can be disposed along the bottom surface of the bottom panel 115. A top surface 300 of the cold plate 165 can be situated to be at least partially flush with the bottom surface of the bottom panel 115. The cold plate 165 can be situated to vertically align the inlet port 215 of the bottom panel 115 to an intake area 310 or 330 on the top surface 300. With the alignment, the inlet port 215 can be fluidly coupled with the intake area 310 or 330 of the cold plate 165. Through the alignment between the intake area 310 or 330 with the inlet port 215, the cold plate 165 can receive the coolant. The cold plate 165 can be situated to vertically align the outlet port 220 of the bottom panel 115 to an outtake area 315 or 335 on the top surface 300. With the alignment, the outlet port 220 can be fluidly coupled with the outtake area 315 or 335 of the cold plate 165. Through the alignment between the outtake area 315 or 335 with the outlet port 220, the cold plate 165 can release the coolant.

The method 600 an include defining channels on the cold plate 165 (ACT 620). The channels defined on the cold plate 165 can include an intake area 310 or 330, an outtake area 315 or 335, a main intake channel 345, a main outtake channel 350, and a set of module channels 400, among others. Each channel can correspond to a depression into the top surface 300 of the cold plate 165 to convey and circulate the coolant throughout the cold plate 165. The intake area 310 and the outtake area 315 can be defined within a collector area 305. The intake area 330 and the outtake area 335 can be defined within a collector area 325. The main intake channel 345 can be defined spanning through an interior portion (e.g., along a midline as depicted in FIG. 3) of the top surface 300 of the cold plate 165. The main outtake channel 350 can be defined spanning along an exterior portion (e.g., along a perimeter as depicted in FIG. 3) of the top surface 300 of the cold plate 165. Each module channel 400 can be defined within a corresponding module region 355 along the top surface 300 of the cold plate 165. The module channel 400 can span between the main intake channel 345 and the main outtake channel 350 to circulate the coolant within the module region 355. Each module channel 400 can be vertically aligned with at least one of the battery modules 145 arranged in the housing 110. The channels can be defined onto the top surface 300 of the cold plate 165 using various techniques, such as etching, braising, hydroforming, pressing, imprinting, and molding, among others.

The method 600 can include arranging a sealing element 170 (ACT 625). The sealing element 170 can be arranged to align with an attachment region 365 defined on a perimeter region of the cold plate 165. The attachment region 365 can correspond to a depression formed on the top surface 300 of the cold plate 165. At least a portion of the sealing element 170 can be inserted into the attachment region 365. The sealing element 170 can mechanically couple the top surface 300 of the cold plate 165 with the bottom surface of the bottom panel 115. The mechanical coupling between the top surface 300 and the bottom surface of the bottom panel 115 via the sealing element 170 can be a seal. The seal can be, for example, as a mechanical seal, such as a hermetic seal, an induction seal, a hydrostatic seal, a hydrodynamic seal, and a bonded seal, among others.

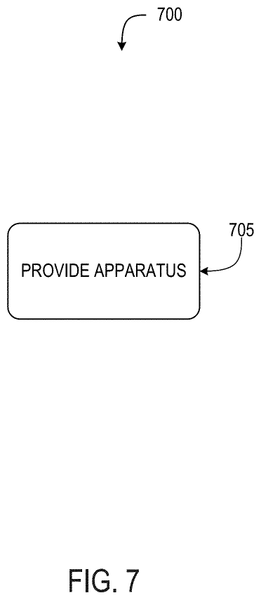

FIG. 7 depicts an example method 700 for providing an apparatus to an electric vehicle. The method 700 can be implemented using any of the components detailed herein in conjunction with FIGS. 1-5. The method can include providing an apparatus 100 (ACT 705). The apparatus 100 can be provided to an electric vehicle 500 to provide electrical power to one or more components 535 of the electric vehicle 500. The apparatus 100 can include a housing 110 for a battery pack 105. The housing 110 can include four lateral sides and a bottom longitudinal side to define a cavity 200. The housing 110 can include a bottom panel 115 along the bottom longitudinal side. The apparatus 100 can include a set of battery modules 145. The set of battery modules 145 can be arranged within the cavity 200 of the housing 110. Each battery module 145 can have a set of battery cells to store electrical energy. Each battery module 145 can be supported by at least a portion of a top surface of the bottom panel 115. Each battery module 145 can be thermally coupled with the bottom panel 115. The apparatus 100 can include an inlet port 215 and an outlet port 220. Both the inlet port 215 and the outlet port 220 can be defined through a top surface and a bottom surface of the bottom panel 115. The inlet port 215 can receive coolant from outside the housing 110. The outlet port 220 can release the coolant from within the housing 110.

The apparatus 100 can also include a cold plate 165. The cold plate 165 can be disposed along the bottom surface of the bottom panel 115. The cold plate 165 can be thermally coupled with the set of battery modules 145 via the bottom panel 115. The cold plate 165 can have a main intake channel 345 defined on a top surface 300. The main intake channel 345 can be fluidly coupled with the inlet port 215 via an intake point to receive the coolant from outside the housing 110. The cold plate 165 can have a main outtake channel 350 defined on the top surface 300. The main outtake channel 350 can be fluidly coupled with the outlet port 220 via an outtake point to release the coolant from the cold plate 165. The cold plate 165 can have a set of module channels 400 defined on the top surface 300. Each module channel 400 can span across a corresponding module region 355 on the top surface 300. Each module channel 400 can span the module region 355 to convey and circulate the coolant across the module region 355. Each module channel 400 can receive the coolant from the main intake channel 345 via an ingress point 415. Each module channel 400 can release the coolant into the main outtake channel 350 via an egress point 420. The apparatus 100 can include a sealing element 170. The sealing element 170 can be arranged along an outer perimeter region of the cold plate 165. The sealing element 170 can mechanically seal the cold plate 165 with the bottom surface of the bottom panel 115 of the housing 110.

While operations may be depicted in the drawings or described in a particular order, such operations are not required to be performed in the particular order shown or described, or in sequential order, and all depicted or described operations are not required to be performed. Actions described herein can be performed in different orders.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. Further, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An apparatus to provide electric power to components in electric vehicles, comprising:
a housing for a battery pack disposed in an electric vehicle to power the electric vehicle, the housing having a bottom panel partially defining a cavity, the bottom panel having a top surface and a bottom surface;
a battery module arranged within the cavity of the housing for the battery pack, the battery module supported by at least a portion of the top surface of the bottom panel and thermally coupled with the top surface of the bottom panel, the battery module having a plurality of battery cells to store electrical energy;
an inlet port defined through the top surface and the bottom surface of the bottom panel to receive fluid from outside the housing;
an outlet port defined through the top surface and the bottom surface of the bottom panel to release the fluid from within the housing;
a cold plate disposed along the bottom surface of the bottom panel of the housing to circulate the fluid, the cold plate thermally coupled with the battery module via the bottom panel, the cold plate having:
a main intake channel spanning along a top surface of the cold plate, the main intake channel having an intake point aligned with the inlet port of the bottom panel to receive the fluid into the cold plate;
a main outtake channel spanning along the top surface of the cold plate, the main outtake channel having an outtake point aligned with the outlet port of the bottom panel to release the fluid out of the cold plate; and
a module channel spanning within a module region of the top surface of the cold plate to convey the fluid from the main intake channel via an ingress point of the module region to the main outtake channel via an egress point of the module region to transfer heat from the battery module; and
a sealing element arranged along a perimeter region of the top surface of the cold plate to mechanically seal the cold plate with the bottom surface of the bottom panel of the housing.

2. The apparatus of claim 1, comprising:
a plurality of battery modules including the battery module and a second battery module both disposed within the cavity of the housing of the battery pack;
the module channel spanning within the module region aligned with the battery module and thermally coupled with the battery module through the bottom panel;
a second module channel spanning within a second module region of the top surface of the cold plate and thermally coupled with the second battery module through the bottom panel, the second module channel to convey fluid from the main intake channel via an ingress point of the second module region to the main outtake channel via an egress point of the module region; and
a divider region corresponding to a portion of the top surface of the cold plate to separate the module channel in the module region from the second module channel in the second module region to prevent direct conveyance of fluid between the module channel and the second module region.

3. The apparatus of claim 1, comprising:
the cold plate having the perimeter region defined at least in part by a first edge, a second edge, a third edge, and a fourth edge of the cold plate, the first edge opposite of the third edge, the second edge opposite of the fourth edge;
the main intake channel spanning from the first edge to the third edge opposite of the first edge through an interior region of the cold plate to convey the fluid from the intake point to the module channel via the ingress point; and
the main outtake channel spanning along at least a portion of the first edge, at least a portion of the second edge, at least a portion of the third edge, and at least a portion of the fourth edge to convey the fluid from the module via the egress point to the outtake point.

4. The apparatus of claim 1, comprising:
the module region having a first edge and a second edge within the cold plate, the first edge opposite of the second edge;
the ingress point defined on the first edge of the module region to allow the fluid to be received into the module channel from the main intake channel; and
the egress point defined on the second edge of the module region to allow the fluid to be released from the module channel to the main outtake channel.

5. The apparatus of claim 1, comprising:
the module region having four edges defining a perimeter of the module region within the cold plate; and
the module channel spanning from the ingress point along at least one of the four edges of the perimeter of the module region to circulate the fluid through the module region to the egress point.

6. The apparatus of claim 1, comprising:
a plurality of battery modules including the battery module and a second battery module both arranged within the cavity of the housing of the battery pack; and
the cold plate having:
a plurality of module regions defined along the top surface of the cold plate, each module region thermally coupled with at least one of the plurality of battery modules; and
a plurality of module channels defined along the top surface of the cold plate, each module channel spanning within one of the plurality of module regions to convey the fluid from the main intake channel via an ingress point for the module channel to the main outtake channel via an egress point for the module channel to transfer heat from the at least one of the plurality of battery modules thermally coupled with the module region.

7. The apparatus of claim 1, comprising:
a support structure situated on a side wall of the housing, the support structure having:
an intake conduit fluidly coupled with inlet port defined through the top surface and the bottom surface of the bottom panel to convey the fluid from outside the housing to the inlet port, the intake conduit having a length less than a length of the side wall; and
an outtake conduit fluidly coupled with outlet port defined through the top surface and the bottom surface of the bottom panel to release the fluid from within the housing via the outlet port, the outtake conduit having a length less than the length of the side wall.

8. The apparatus of claim 1, comprising:
the cold plate having a collector area located in one end of the cold plate protruding relative to a side wall of the housing, the collector area having:
an intake area for the intake point of the main intake channel aligned with the inlet port of the bottom panel;
an outtake area for the outtake point of the main outtake channel aligned with the outlet port of the bottom panel; and
a divider element to separate the intake area for the intake point from the outtake area for the outtake point.

9. The apparatus of claim 1, comprising:
a cover element disposed along a bottom surface of the cold plate to hold the cold plate against the bottom surface of the bottom panel, the envelope element in contact with the bottom surface of the cold plate and mechanically coupled with the bottom surface of the bottom panel.

10. The apparatus of claim 1, comprising:
the cold plate having an attachment region along the perimeter region of the top surface of the cold plate to hold at least a portion of the sealing element to mechanically seal the cold plate with the bottom surface of the bottom panel to prevent leakage of the fluid from the cold plate.

11. The apparatus of claim 1, comprising:
the module region of the top surface of the cold plate longitudinally aligned with a bottom surface of the battery module in the cavity of the housing for the battery pack, the module region thermally coupled with the bottom surface of the battery pack through the bottom panel.

12. The apparatus of claim 1, comprising:
the module channel having a plurality of segments to circulate the fluid through the module region, at least one of the plurality of segments having a set of ridges to regulate a flow rate of the fluid through the module channel received from the main intake channel via the ingress point.

13. The apparatus of claim 1, comprising:
the main intake channel defining a set of ridges to regulate a flow rate of the fluid through the main intake channel to convey into the module channel via the ingress point.

14. The apparatus of claim 1, comprising:
the cold plate having a single monolithic structure, the main intake channel, the main outtake channel, and the module channel all formed from the single monolithic structure of the cold plate.

15. An electric vehicle, comprising:
one or more components;
a housing for a battery pack to power the one or more components, the housing having a bottom panel partially defining a cavity, the bottom panel having a top surface and a bottom surface;
a battery module arranged within the cavity of the housing for the battery pack, the battery module supported by at least a portion of the top surface of the bottom panel and thermally coupled with the top surface of the bottom panel, the battery module having a plurality of battery cells to store electrical energy;
an inlet port defined through the top surface and the bottom surface of the bottom panel to receive fluid from outside the housing;
an outlet port defined through the top surface and the bottom surface of the bottom panel to release the fluid from within the housing;
a cold plate disposed along the bottom surface of the bottom panel of the housing to circulate the fluid, the cold plate thermally coupled with the battery module via the bottom panel, the cold plate having:
a main intake channel spanning along a top surface of the cold plate, the main intake channel having an intake point aligned with the inlet port of the bottom panel to receive the fluid into the cold plate;
a main outtake channel spanning along the top surface of the cold plate, the main outtake channel having an outtake point aligned with the outlet port of the bottom panel to release the fluid out of the cold plate; and
a module channel spanning within a module region of the top surface of the cold plate to convey the fluid from the main intake channel via an ingress point of the module region to the main outtake channel via an egress point of the module region to transfer heat from the battery module; and
a sealing element arranged along a perimeter region of the top surface of the cold plate to mechanically seal the cold plate with the bottom surface of the bottom panel of the housing.

16. The electric vehicle of claim 15, comprising:
the cold plate having the perimeter region defined by a first edge, a second edge, a third edge, and a fourth edge of the cold plate, the first edge opposite of the third edge, the second edge opposite of the fourth edge;
the main intake channel spanning from the first edge to the third edge opposite of the first edge through an interior region of the cold plate to convey the fluid from the intake point to the module channel via the ingress point; and
the main outtake channel spanning along at least a portion of the first edge, at least a portion of the second edge, at least a portion of the third edge, and at least a portion of the fourth edge to convey the fluid from the module via the egress point to the outtake point.

17. The electric vehicle of claim 15, comprising:
a plurality of battery modules including the battery module and a second battery module both disposed within the cavity of the housing of the battery pack; and
the cold plate having:
a plurality of module regions defined along the top surface of the cold plate, each module region thermally coupled with at least one of the plurality of battery modules; and
a plurality of module channels defined along the top surface of the cold plate, each module channel spanning within one of the plurality of module regions to convey the fluid from the main intake channel via an ingress point for the module channel to the main outtake channel via an egress point for the module channel to transfer heat from the at least one of the plurality of battery modules thermally coupled with the module region.

18. A method of providing electric power to components in electric vehicles, comprising:
disposing a housing for a battery pack in an electric vehicle to power the electric vehicle, the housing having a bottom panel partially defining a cavity, the bottom panel having a top surface and a bottom surface;
arranging a battery module within the cavity of the housing for the battery pack, the battery module supported by at least a portion of the top surface of the bottom panel and thermally coupled with the top surface of the bottom panel, the battery module having a plurality of battery cells to store electrical energy;
defining an inlet port and an outlet port each through the top surface and the bottom surface of the bottom panel to receive fluid from outside the housing;
disposing a cold plate along the bottom surface of the bottom panel of the housing to circulate the fluid, the cold plate thermally coupled with the battery module via the bottom panel, the cold plate having:
a main intake channel spanning along a top surface of the cold plate, the main intake channel having an intake point aligned with the inlet port of the bottom panel to receive the fluid into the cold plate;
a main outtake channel spanning along the top surface of the cold plate, the main outtake channel having an outtake point aligned with the outlet port of the bottom panel to release the fluid out of the cold plate; and
a module channel spanning within a module region of the top surface of the cold plate to convey the fluid from the main intake channel via an ingress point of the module region to the main outtake channel via an egress point of the module region to transfer heat from the battery module; and
arranging a sealing element along a perimeter region of the top surface of the cold plate to mechanically seal the cold plate with the bottom surface of the bottom panel of the housing.

19. The method of claim 18, comprising:
disposing the cold plate, the cold plate having the perimeter region defined by a first edge, a second edge, a third edge, and a fourth edge of the cold plate, the first edge opposite of the third edge, the second edge opposite of the fourth edge;
defining the main intake channel to span from the first edge to the third edge opposite of the first edge through an interior region of the cold plate to convey the fluid from the intake point to the module channel via the ingress point; and
defining the main outtake channel to span along at least a portion of the first edge, at least a portion of the second edge, at least a portion of the third edge, and at least a portion of the fourth edge to convey the fluid from the module via the egress point to the outtake point.

20. The method of claim 18, comprising:
arranging a plurality of battery modules including the battery module and a second battery module both within the cavity of the housing of the battery pack
defining a plurality of module regions along the top surface of the cold plate, each module region thermally coupled with at least one of the plurality of battery modules; and
defining a plurality of module channels along the top surface of the cold plate, each module channel spanning within one of the plurality of module regions to convey the fluid from the main intake channel via an ingress point for the module channel to the main outtake channel via an egress point for the module channel to transfer heat from the at least one of the plurality of battery modules thermally coupled with the module region.
